(19) United States
(12) Patent Application Publication
(10) Pub. No.: US 2026/0001598 A1
(43) Pub. Date: Jan. 1, 2026

(54) VEHICLE

(71) Applicant: NISSAN NORTH AMERICA, INC., Franklin, TN (US)

(72) Inventor: Mark BAILEY, Seattle, WA (US)

(21) Appl. No.: 18/759,453

(22) Filed: Jun. 28, 2024

(51) Int. Cl. B62D 37/04

(52) U.S. Cl. CPC B62D 37/04

(57) ABSTRACT

A vehicle includes a battery module compartment, a sensor network, a vehicle battery and an electronic controller. The sensor network is provided on the vehicle and including at least one weight sensor to detect weight distribution information regarding the vehicle. The sensor network further includes at least one environmental sensor configured to detect information regarding the vehicle's vicinity. The vehicle battery is movably mounted on a battery mounting device provided in the battery module compartment. The electronic controller is in electronic communication with the sensor network to receive the detected weight distribution information. The electronic controller is electronically controlling the battery mounting device to adjust a mounting position of the vehicle battery based on at least one of the weight distribution information and the information regarding the vehicle's vicinity.

### BACKGROUND

### Technical Field

The present disclosure generally relates to a vehicle. More specifically, the present disclosure relates to a vehicle equipped with a battery mounting system.

### Background Information

Electric powered vehicles are powered by vehicle batteries that can be comprised of hundreds of individual cells packed into modules of pockets to make one large singular battery that is placed under a floor of the vehicle in a skateboard configuration.

### SUMMARY

In view of the state of the known technology, one aspect of the present disclosure is to provided a vehicle comprising a battery module compartment, a sensor network, a vehicle battery and an electronic controller. The sensor network is provided on the vehicle and including at least one weight sensor to detect weight distribution information regarding the vehicle. The sensor network further includes at least one environmental sensor configured to detect information regarding the vehicle's vicinity. The vehicle battery is movably mounted on a battery mounting device provided in the battery module compartment. The electronic controller is in electronic communication with the sensor network to receive the detected weight distribution information. The electronic controller is electronically controlling the battery mounting device to adjust a mounting position of the vehicle battery based on at least one of the weight distribution information and the information regarding the vehicle's vicinity.

### BRIEF DESCRIPTION OF THE DRAWINGS

Referring now to the attached drawings which form a part of this original disclosure:

FIG. 1 is a perspective view of a vehicle equipped with a battery mounting device in accordance with an illustrated embodiment;

FIG. 2 is a schematic view of the vehicle that is equipped with the battery mounting device;

FIG. 3 is a perspective view of the battery mounting device supporting a vehicle battery;

FIG. 4 is a flowchart showing an electronic controller control of a mounting position of the vehicle equipped with the battery mounting device;

FIG. 5 is another flowchart showing the electronic controller control of a mounting position of the vehicle equipped with the battery mounting device; and

FIG. 6 is a modified battery mounting device that is implemented with the vehicle battery.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

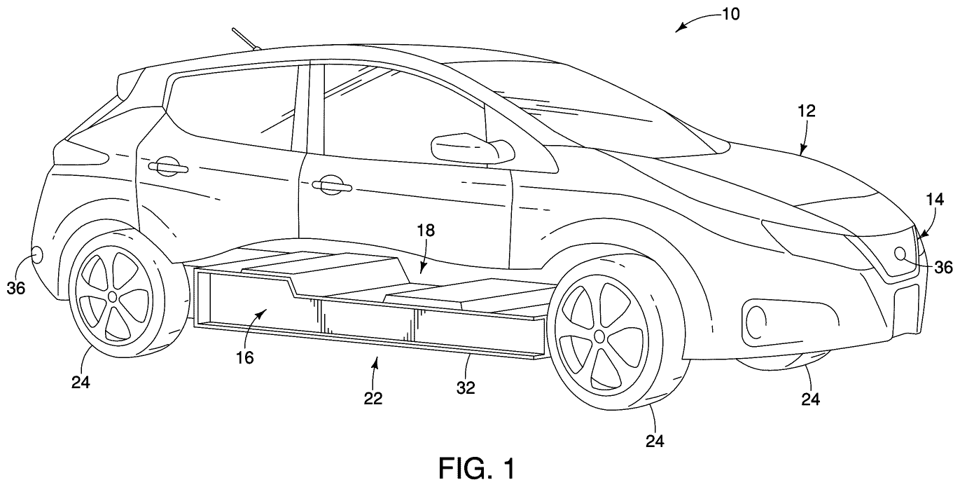

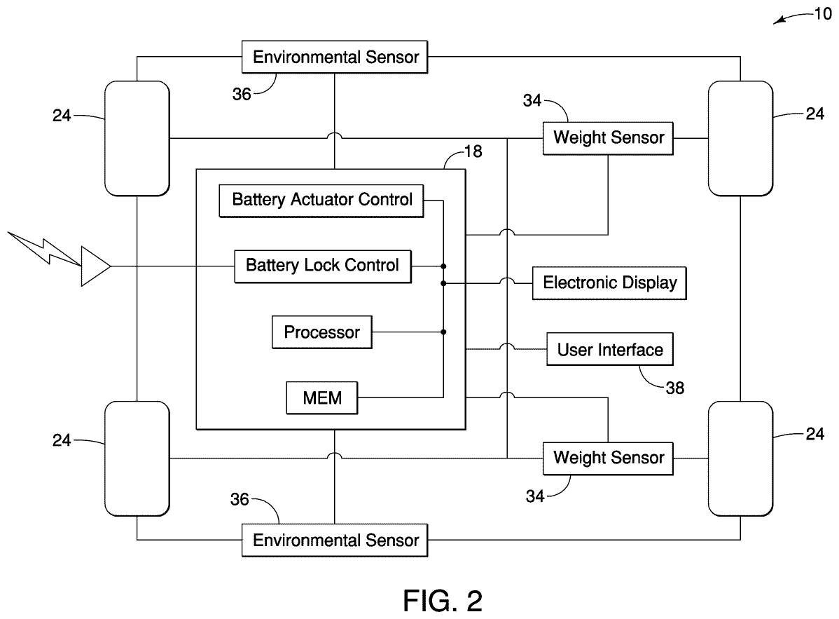

Referring initially to FIGS. 1 and 2, a vehicle comprises a vehicle body 12, a sensor network 14, a vehicle battery 16 and an electronic controller 18 in accordance with an embodiment. The vehicle body 12 has a battery module compartment 18. The vehicle battery 16 is movably mounted on a battery mounting device 20 provided in the battery module compartment 18, as will be further described herein. In the illustrated embodiment, the electronic controller 18 is in communication with the sensor network 14 to electronically control the battery mounting device 20 to adjust a mounting position of the vehicle battery 16 based on information received from the sensor network 14. In particular, the electronic controller 18 is configured to adjust the mounting position of the battery 16 based on at least one of the weight distribution information and the information regarding the vehicle's 10 vicinity, as will be further discussed.

In the illustrated embodiment, the vehicle 10 is an electric powered vehicle that is powered by the battery 16. The battery 16 is comprised of hundreds of individual cells packed into modules of pockets to make one large singular battery 16 that is placed under a floor of the vehicle 10 in a skateboard configuration, as shown in FIG. 1. The vehicle 10 includes a chassis 22 defining the battery module compartment 18 underneath the vehicle floor. The battery 16 is insertable into the battery module compartment 18 of the chassis 22. The vehicle 10 can include an access door (not shown) to enable access to the battery module compartment 18. The chassis 22 and the vehicle body 12 can be formed integrally in a unibody construction. The chassis 22 and the vehicle body 12 are supported on the vehicle wheels 24.

The vehicle 10 of the illustrated embodiment includes the battery mounting device 20 that movably mounts the battery 16 inside the battery module compartment 18, as will be further described below. In particular, the battery mounting device 20 can include a battery tray 32 having an ignition contact to provide an electrical connection between the battery tray 32 and an ignition system of the vehicle 10. The battery 16 is provided on the battery tray 32 that is together with the battery 16 movably disposed in the battery module compartment 18. In the illustrated embodiment, the battery mounting device 20 further includes a locking mechanism for locking the battery 16 module within the battery module compartment 18 of the chassis 22 at different mounting positions of the battery 16 as needed and/or desired.

The sensor network 14 is provided on the vehicle 10 and includes at least one weight sensor 34 and at least one environmental sensor. The weight sensor 34 detects weight distribution information regarding the vehicle 10. Preferably, the sensor network 14 includes a plurality of weight sensors 34 designed to detect or determine weight distribution across the vehicle 10, particularly on the vehicle axles and/or the wheels. For example, the weight sensors 34 can be position sensors that can measure the weight or load on the vehicle's front and rear axles using leaf spring suspension(s). Alternatively, the weight sensors 34 can be pressure sensors that can determine the load on the vehicle axles equipped by measuring the pressure in the vehicle pneumatic system. It will be apparent to those skilled in the vehicle field from this disclosure that the weight sensors 34 can be any type of appropriate sensors that can detect or determine the weight distribution of the vehicle 10 between the left and right wheels and the weight distribution between the front and rear wheels. In the illustrated embodiment, the mounting position of the battery 16 within the battery module compartment 18 influences the weight distribution of the vehicle 10.

Preferably, the sensor network 14 further includes a plurality of environmental sensors 36 configured to detect information regarding the vehicle's 10 vicinity. For example, the vehicle 10 can be equipped with one or more unidirectional or omnidirectional external cameras that take moving or still images of the vehicle surroundings. In addition, the external cameras can be capable of detecting the speed, direction, yaw, acceleration and distance of the vehicle 10 relative to a remote object. The environmental sensors 36 can also include infrared detectors, ultrasonic detectors, radar detectors, photoelectric detectors, magnetic detectors, acceleration detectors, acoustic/sonic detectors, gyroscopes, lasers or any combination thereof. The environmental sensors 36 can also include object-locating sensing devices including range detectors, such as FM-CW (Frequency Modulated Continuous Wave) radars, pulse and FSK (Frequency Shift Keying) radars, sonar and Lidar (Light Detection and ranging) devices. The data from the environmental sensors 36 can be used to determine information about the vehicle's 10 vicinity. The electronic controller 18 is in electronic communication with the sensor network 14 to receive the detected weight distribution information and the detected environmental information.

The vehicle 10 is further equipped with a user interface 38 in communication with the electronic controller 18. The user interface 38 can include control buttons and/or control buttons displayed on a touchscreen display (e.g., hard buttons and/or soft buttons) which enable the user to enter commands and information for use by the ECU to control various aspects of the vehicle 10. The user interface 38 can also include a microphone that enables the user to enter commands or other information vocally. The electronic controller 18 is further configured to adjust the mounting position of the vehicle battery 16 based on information received from the user interface 38, as will be further discussed below.

Conventional batteries are mounted during vehicle assembly and cannot be adjusted dynamically. The vehicle 10 is provided with the dynamically mounted vehicle battery 16 to enable a less economical and more sporty ride. Therefore, dynamic battery adjustment can be enabled when the vehicle enters a sports mode in which the driver can select a desired vehicle weight distribution during driving. Additionally, the electronic controller 18 can control the battery mounting position based on vehicle slippage and conditions detected by the sensor network 14, as described below.

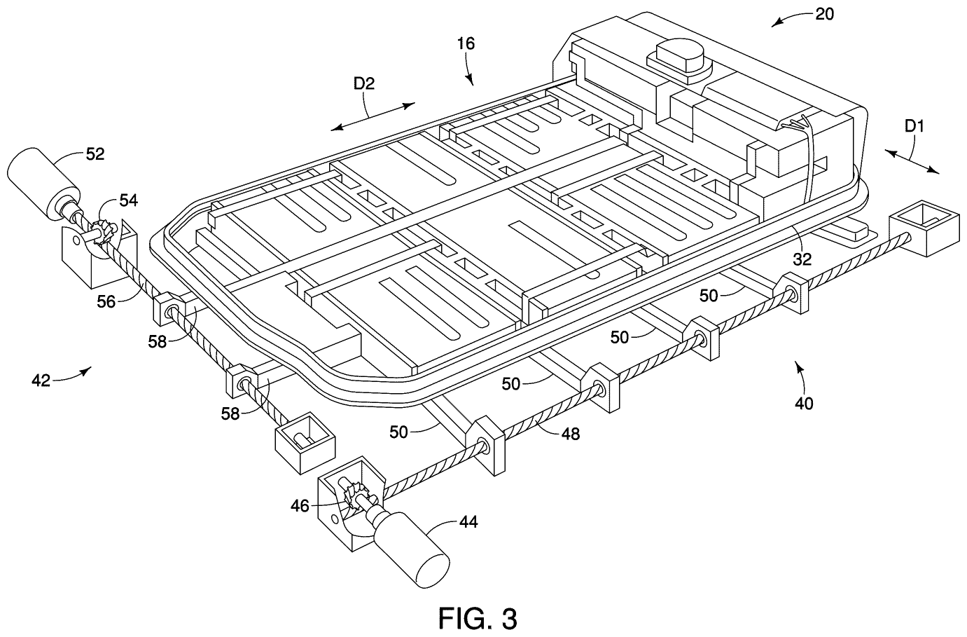

Referring to FIG. 3, the battery mounting device 20 will be further discussed. The battery mounting device 20 of the illustrated embodiment includes a first linear displacement device 40 configured to provide linear adjustment of the vehicle battery 16 along a first direction D1. In the illustrated embodiment, the first direction D1 is a lateral (left-right side) direction of the vehicle. The battery mounting device 20 further includes a second linear displacement device 42 configured to provide linear adjustment of the vehicle battery 16 along a second direction that is perpendicular to the first direction D1. As shown, the first direction D1 is a longitudinal (lengthwise) direction of the vehicle. Therefore, the first and second directions D1 and D2 are perpendicular with respect to each other.

The first linear displacement device 40 includes a first actuator 44 and a first gear 46 that is powered by the first actuator 44. The first linear displacement device 40 further includes a first track 48 extending along the longitudinal direction of the vehicle 10 and operatively engaging the first gear 46. In particular, the first track 48 is an elongated screw having teeth or abutments that operatively engage the teeth of the first gear 46. The first actuator 44 drives the first gear 46 such that rotation of the first gear 46 causes the first track 48 to rotate.

The first linear displacement device 40 further includes at least one first support platform 50 that supports the battery tray 32 with respect to the first track 48. As shown, the first linear displacement 40 preferably includes a plurality of first support platforms 50 provided along the first track 48 to movably support the battery 16 vehicle battery 16 along the first track 48. Upon rotation of the first track 48, the first support platforms 50 move the battery tray 32 along the vehicle lateral direction to adjust weight distribution of the vehicle 10 along the vehicle lateral direction. The first actuator 44 includes a first motor that is configured to adjust the relative position of the battery 16 in discrete steps in the vehicle lateral direction.

The second linear displacement device 42 includes a second actuator 52, a second gear 54 that is powered the second actuator 52, and a second track 56 extending along the lateral direction and engaging the second gear 54. In particular, the second track 56 is an elongated screw having teeth or abutments that operatively engage the teeth of the second gear 54. The second actuator 52 drives the second gear 54 such that rotation of the second gear 54 causes the second track 56 to rotate.

The second linear displacement device 42 includes at least one second support platform 58 provided on the second track 56 to movably support the battery 16 vehicle battery 16 along the second track 56. In particular, the second linear displacement device 42 includes a plurality of second support platforms 58 provided along the second track 56 to movably support the battery 16 along the second track 56. Upon rotation of the second track 56, the second support platforms 58 move the battery tray 32 along the vehicle longitudinal direction to adjust weight distribution of the vehicle 10 along the vehicle longitudinal direction. The second actuator 52 includes a second motor that is configured to adjust the relative position of the battery 16 in discrete steps in the vehicle longitudinal direction. Preferably, the first motor and the second motor are reversible electric stepper motors.

The battery mounting device 20 further includes a locking device (not shown). The electronic controller 18 controls the first and second motors to operate the first and second linear displacement devices 40 and 42 accordingly. The electronic controller 18 further controls the locking device to lock the battery tray 32 in a desired mounting position. The locking device can include conventional locking units disposed on the first and second support platforms 50 and 58.

As stated, the electronic controller 18 is configured to control the first and second linear displacement devices 40 and 42 to adjust the mounting position of the battery 16 in the lateral and longitudinal directions of the vehicle in accordance with a detected weight distribution of the vehicle and/or information regarding the vehicle's vicinity, such as the presence of obstacles, snow, ice, rocky terrain, etc.

The electronic controller 18 includes a processor for controlling the operation of the battery mounting device 20. The electronic controller 18 further has a non-transitory computer readable medium MEM. In the illustrated embodiment, the non-transitory computer readable medium MEM stores predetermined battery 16 mounting positions in the vehicle lateral and longitudinal directions. As used herein, the terminology “processor” indicates one or more processors, such as one or more special purpose processors, one or more digital signal processors, one or more microprocessors, one or more controllers, one or more microcontrollers, one or more application processors, one or more Application Specific Integrated Circuits, one or more Application Specific Standard Products; one or more Field Programmable Gate Arrays, any other type or combination of integrated circuits, one or more state machines, or any combination thereof.

As used herein, the terminology “memory” or “computer-readable medium MEM” (also referred to as a processor-readable medium MEM) indicates any computer-usable or computer-readable medium MEM or device that can tangibly contain, store, communicate, or transport any signal or information that may be used by or in connection with any processor. For example, the computer readable medium MEM may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

Therefore, the computer-readable medium MEM further includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media can include, for example, optical or magnetic disks and other persistent memory. Volatile media may include, for example, dynamic random access memory (DRAM), which typically constitutes a main memory.

The computer readable medium MEM can also be provided in the form of one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The processor can execute instructions transmitted by one or more transmission media, including coaxial cables, copper wire and fiber optics, including the wires that comprise a system bus coupled to a processor of a computer. As used herein, the terminology “instructions” may include directions or expressions for performing any method, or any portion or portions thereof, disclosed herein, and may be realized in hardware, software, or any combination thereof.

For example, instructions may be implemented as information, such as a computer program, stored in memory that may be executed by the processor to perform any of the respective methods, algorithms, aspects, or combinations thereof, as described herein. In some embodiments, instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

Computer-executable instructions can be compiled or interpreted from computer programs created using a variety of programming languages and/or technologies, including, without limitation, and either alone or in combination, Java™, C, C++, Visual Basic, Java Script, Perl, etc. In general, the processor 20 receives instructions from the computer-readable medium MEM and executes these instructions, thereby performing one or more processes, including one or more of the processes described herein. Such instructions and other data may be stored and transmitted using a variety of computer-readable media.

As seen in FIG. 2, the processor is operatively coupled with the computer readable medium MEM, the input interface, the sensor network 14. Additionally, the processor can be operatively coupled with features of the vehicle's 10 navigation system to receive information regarding vehicle travel, vehicle speed, acceleration, deceleration, reverse travel, etc.

As stated, the electronic controller 18 can control the first and second linear displacement devices 40 and 42 accordingly. For example, the environmental sensors 36 and/or the vehicle navigation can notify the electronic controller 18 that the vehicle 10 is traveling around corners which can cause slippage between the vehicle's 10 left and right wheels. The electronic controller 18 can be configured to control the first linear displacement device 40 to provide linear adjustment of the battery 16 along the lateral direction such that weight increases on the inner wheels with respect to the other wheels to increase traction on the inner wheels. Once the curve passes and the vehicle is again traveling straight, the electronic controller 18 can then control the first linear displacement device 40 to move the mounting position of the battery 16 such that the weight distribution between the left and right wheels is approximately 50/50. The electronic controller 18 can then lock the locking device such that the weight distribution stays at 50/50 between the left and right wheels.

Additionally, the electronic controller 18 can control the left and right wheels to maintain a balanced weight distribution between the left and right wheels. For example, in a default mode, the electronic controller 18 can be configured to control the first linear displacement device 40 to provide linear adjustment direction along the lateral upon determining a weight differential between vehicle's left and right wheels exceeds a predetermined differential threshold, such as whenever the weight distribution differential between the left and right wheels is no longer at 50/50. In the illustrated embodiment, a user can set the predetermined threshold for linear displacement along the longitudinal direction to a desired amount during sports mode for an enhanced driving experience. Therefore, the electronic controller 18 is configured to control the first linear displacement device 40 to provide linear adjustment direction along the lateral direction upon determining a weight differential between vehicle's 10 left and right wheels exceeds a predetermined differential threshold.

Additionally, the electronic controller 18 can be configured to control the second linear displacement device 42 to provide linear adjustment direction along the longitudinal direction upon determining the vehicle 10 is on mountainous terrain to adjust the weight distribution between the front and rear wheels. In this instance, the environmental sensors 36 can determine the presence of rough terrain, mud, dirt, rocks, or other obstacles in the vehicle's vicinity. The electronic controller 18 can then control the second linear displacement device 42 to adjust the mounting position of the battery 16 to increase the weight on the front wheels to increase traction on the front wheels for the duration of mountainous terrain travel.

Similarly, the environmental sensors 36 can sense the presence of slippery conditions, such as the presence of snow and/or ice causing the vehicle 10 to become stuck on a snow or ice patch. In this instance, the electronic controller 18 can control the second linear displacement to cause the battery 16 to move longitudinally backwards and forwards in order to create a rocking motion for the vehicle 10 to rock the vehicle 10 out of a snow or ice patch. Therefore, the electronic controller 18 is configured to control the second linear displacement device 42 to provide linear adjustment direction along the second direction upon determining the vehicle 10 is traveling on slippery terrain.

Additionally, the electronic controller 18 can control the front and rear wheels to maintain a balanced weight distribution between the left and right wheels. For example, in a default mode, the electronic controller 18 can be configured to control the second linear displacement device 42 to provide linear adjustment direction along the second direction upon determining a weight differential between vehicle's 10 front and rear wheels exceeds a predetermined differential threshold, such as whenever the weight distribution differential between the front and rear wheels is no longer at 50/50. In the illustrated embodiment, a user can set the predetermined threshold for linear displacement along the lateral direction to a desired amount during sports mode for an enhanced driving experience.

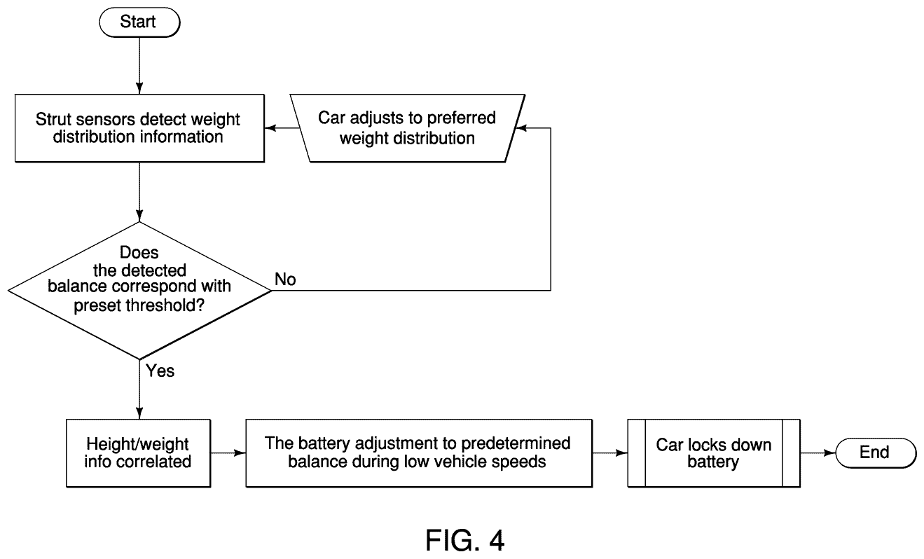

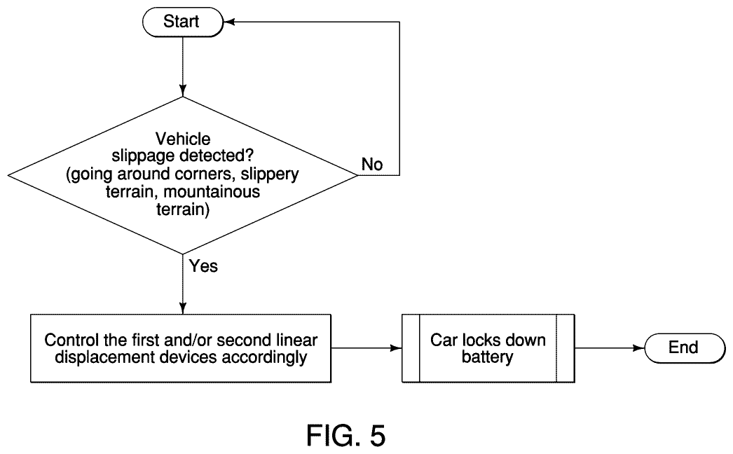

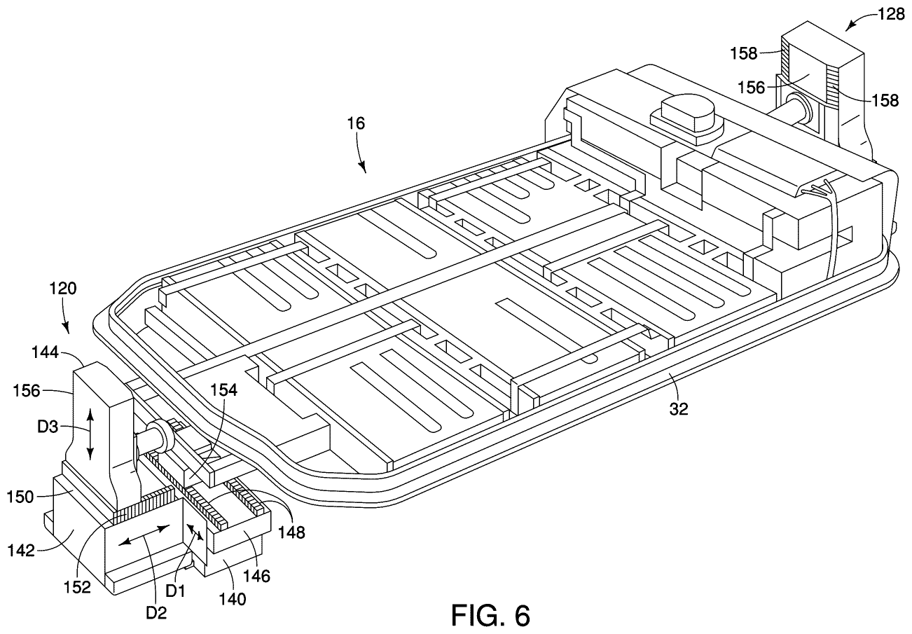

Referring now to FIG. 6, a modified battery mounting device 120 that can be implemented with the vehicle having the vehicle battery 16 of FIGS. 1 to 5 is illustrated. The modified battery mounting device 120 includes a first modified linear displacement device 140, a second modified linear displacement device 142, and a third linear displacement device 144. The third linear displacement device 144 enables the modified battery mounting device 20 to move the battery 16 in a vehicle height direction (i.e., up and down). Therefore, the modified battery mounting device 20 further includes the third linear displacement device 144 configured to provide linear adjustment of the vehicle battery 16 along a third direction D3 that is the height (up and down) direction of the vehicle 10.

As shown, the first linear displacement device 40 includes a first platform 146 having a pair of first tracks 148 extending along the first direction D1 (lateral direction). The second linear displacement device 142 includes a second platform 150 having a pair of second tracks 152 extending along the second direction (longitudinal direction). The modified battery mounting device 120 includes a first battery mounting table 154 that moves between the first and second track 148 and 152. The battery 16 is movably mounted to move along the first and second tracks 148 and 152 via the first battery mounting table 154.

The third linear displacement device 144 includes a third platform 146 having a pair of third tracks 158 extending along the height direction. The modified battery mounting device 120 includes a second battery mounting table 160 movably mounted on the third tracks 158. The third platform 156 is supported to one of the first and second platforms 146 and 150. The third platform 156 is shown as supported to the second platform 150 as shown, but can alternatively be supported to the first platform 146 as needed and/or desired. The vehicle battery 16 is mounted on the second battery mounting table 160 to enable movement in the height direction. The battery 16 is mounted on the first battery mounting table 154 to enable movement in the longitudinal and lateral directions.

The electronic controller 18 can be configured to control the third linear displacement device 144 to provide linear adjustment direction along the height direction based on manual input from a vehicle operator. For example, during a manual control or a race mode, the user can input a desired height for the battery 16 into the user interface 38 and the electronic controller 18 can control the third linear displacement device 144 accordingly.

Alternatively, the electronic controller 18 can control the third linear displacement device 144 to avoid large obstacles on the road. For example, the environmental sensors 36 can detect the presence of large obstacles on the road. Upon detection, the electronic controller 18 can control the third linear displacement device 144 to adjust the mounting position of the battery 16 in the height direction to avoid hitting the obstacle. The electronic controller 18 can then control the third linear displacement device 144 to return the battery 16 to a default height once the obstacle passes. As shown in FIG. 6, the vehicle battery 16 is provided as being supported to a pair of modified battery mounting devices 120 that are identical. While the modified battery mounting devices 120 are provided on the longitudinal sides of the battery 16, it will be apparent to those skilled in the vehicle field from this disclosure that the modified battery mounting devices 120 can be provided on the lateral sides of the battery 16 as needed and/or desired.

It will be apparent to those skilled in the vehicle field from this disclosure that the structures of the battery mounting device 20 and the modified battery mounting device 20 can include circuitry or other types of communication hardware (wired or wireless) to send and receive signals to and from the electronic controller 18 as needed.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle. Accordingly, these terms, as utilized to describe the present invention should be interpreted relative to a vehicle equipped with the vehicle.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle comprising:
a vehicle body having a battery module compartment;
a sensor network provided on the vehicle and including at least one weight sensor to detect weight distribution information regarding the vehicle, the sensor network further including at least one environmental sensor configured to detect information regarding the vehicle's vicinity;
a vehicle battery movably mounted on a battery mounting device provided in the battery module compartment; and
an electronic controller in electronic communication with the sensor network to receive the detected weight distribution information, the electronic controller electronically controlling the battery mounting device to adjust a mounting position of the vehicle battery based on at least one of the weight distribution information and the information regarding the vehicle's vicinity.

2. The vehicle according to claim 1, wherein
the battery mounting device includes a first linear displacement device configured to provide linear adjustment of the vehicle battery along a first direction, the battery mounting device further includes a second linear displacement device configured to provide linear adjustment of the vehicle battery along a second direction that is perpendicular to the first direction.

3. The vehicle according to claim 2, wherein
the first direction is a lateral direction of the vehicle, the electronic controller being configured to control the first linear displacement device to provide linear adjustment direction along the first direction upon determining a weight differential between vehicle's left and right wheels exceeds a predetermined differential threshold.

4. The vehicle according to claim 3, wherein
the second direction is a longitudinal direction of the vehicle, the electronic controller being configured to control the second linear displacement device to provide linear adjustment direction along the second direction upon determining a weight differential between vehicle's front and rear wheels exceeds a predetermined differential threshold.

5. The vehicle according to claim 2, wherein
the second direction is a longitudinal direction of the vehicle, the electronic controller being configured to control the second linear displacement device to provide linear adjustment direction along the second direction upon determining the vehicle is on mountainous terrain.

6. The vehicle according to claim 5, wherein
the second direction is a longitudinal direction of the vehicle, the electronic controller being configured to control the second linear displacement device to provide linear adjustment direction along the second direction upon determining the vehicle is traveling on slippery terrain.

7. The vehicle according to claim 2, wherein
the first linear displacement device includes a first actuator, a first gear that is powered by the first actuator, and a first track extending along a longitudinal direction of the vehicle and engaging the first gear.

8. The vehicle according to claim 7, wherein
the first linear displacement device includes at least one first support platform provided on the first track to movably support the battery vehicle battery along the first track.

9. The vehicle according to claim 8, wherein
the second linear displacement device includes a second actuator, a second gear that is powered by the second actuator, and a second track extending along a lateral direction of the vehicle and engaging the second gear.

10. The vehicle according to claim 9, wherein
the second linear displacement device includes at least one second support platform provided on the second track to movably support the battery vehicle battery along the second track.

11. The vehicle according to claim 2, wherein
the first linear displacement device includes a first platform having a pair of first tracks extending along a longitudinal direction of the vehicle.

12. The vehicle according to claim 11, wherein
the second linear displacement device includes a second platform having a pair of second tracks extending along a lateral direction of the vehicle, the battery being movably mounted to move along the first and second tracks.

13. The vehicle according to claim 12, wherein
the battery mounting device further includes a third linear displacement device configured to provide linear adjustment of the vehicle battery along a height direction of the vehicle.

14. The vehicle according to claim 13, wherein
the third linear displacement device includes a third platform having a pair of third tracks extending along the height direction, the third platform being supported to one of the first and second platforms.

15. The vehicle according to claim 14, wherein
the vehicle battery is mounted on the third platform.

16. The vehicle according to claim 15, wherein
the electronic controller being configured to control the third linear displacement device to provide linear adjustment direction along the height direction based on manual input from a vehicle operator.

17. The vehicle according to claim 1, further comprising
a user interface in communication with the electronic controller, the electronic controller being further configured to adjust a mounting position of the vehicle battery based on information received from the user interface.
